(19) United States
(12) Patent Application Publication
(10) Pub. No.: US 2002/0173304 A1
(43) Pub. Date: Nov. 21, 2002

(54) Method for dynamic access of information over a wireless network

(76) Inventor: Huba Horompoly, Redwood City, CA (US)

Correspondence Address: Randy Merritt, 1116 Fairview Ave., San Jose, CA, 95125, US

(21) Appl. No.: 10/143,607

(22) Filed: May 10, 2002

Related U.S. Application Data
(60) Provisional application No. 60/291,897, filed on May 18, 2001.

(51) Int. Cl. H04Q 7/20

(52) U.S. Cl. 455/426; 455/567; 455/557

(57) ABSTRACT

A method for transmitting messages as alerts originating from backend information systems to wireless devices using a wireless communication network is provided. Such alerts represent events of interest subscribed to and managed by users. Alert messages may be transmitted to users in a format they define compatible with their wireless device. Alert messages may also include the ability to be configured to occur based on associated logical conditions, to include the execution of a process or back-end transaction, or to be transmitted based on the availability of the intended receiving device.

### BACKGROUND OF THE MENTION

1. Field of the Invention

The present invention relates generally to systems for transmitting messages originating from backend information systems (source systems) such as Enterprise Resource Planning (ERP), Customer Relationship Management (CRM) systems, or generic Internet content over a wireless communication network. Such messages represent alerts regarding events of interest to users subscribed to information in such information systems. Messages that qualify are then transmitted to the users over a wireless communication network in a format they define compatible with their wireless device.

2. Description of Related Art

U.S. Pat. No. 6,055,229, to Dorenbosch, covers optimization of transmitted data formatted based on physical (link) transmission speeds. This application covers the formatting of data to be transmitted based on a priori knowledge of network link latency and the adjustment of the data format to minimize such latency for transmissions that may need to utilize a slow link.

U.S. Pat. No. 5,918,158, to LaPorta, relates to the narrower scope of 2-way paging systems. Pager users can transmit limited messages only to other pager users, and the application makes no provision for the broader interface to existing application systems and the subscribing to tailored event alerts.

U.S. Pat. No. 5,867,688, to Simmon, covers the invention of a wireless handheld device and its internal operation as a method of providing a device to access external data sources. This application cites examples of “on demand” retrieval of certain information whereas the present invention calls for a subscribed “push” of any data supported by any back-end application.

### OBJECTS OF THE INVENTION

It is therefore an object of the present invention to provide a method for the generation of messages that comprise alerts based on events of interest subscribed by a user using a device tailored for use with a wireless network.

It is another object of the present invention to provide a method for the configuration of alerts based on type of occurrence, with condition parameters attached.

It is still another object of the present invention to provide a method for alerts to trigger the execution of a process or transaction.

It is another object of the present invention to provide a method for event occurrences to be captured in a way to enable users to do attribute comparisons from multiple systems.

It is still another object of the present invention to provide a method for basing the source and destination of alerts on a single user, a logical grouping of users, or to one or more identified physical devices.

It is still a further object of the present invention to provide a method for the defining of a role to include general hierarchical structures.

It is another object of the present invention to provide a method for alerts to be sent from the originating system in their native format.

It is still another object of the present invention to provide a method for users to interact with alerts in a dynamic fashion.

It is another object of the present invention to provide a method for the sending of alert messages based on the availability of an identified receiving device.

### SUMMARY OF THE INVENTION

A preferred embodiment of the present invention comprises a system and method for delivering messages originating from an information system over a wireless communication network where the message may undergo formatting suitable for proper display with a hand-held wireless device.

The present invention generates near real-time messages to wireless devices in the form of alerts, depending on either user selections or events and triggers. Alerts can also be identified and generated by a user, role or device to be sent to other users, devices, or systems. Roles that receive alerts can be defined along organizational or other hierarchical structures. Users can format their alert messages to their personal preferences, including settings based on characteristics specific to different devices. Additionally the present invention allows for alert messages to be sent out by the system in their native format as well as allowing the user to interact with the alerts in an intelligent fashion. Alerts can be sent based on device availability. The system can re-route the alerts to alternate device(s) if the default device of the user is temporarily unavailable.

The created alerts emitted from the system are stored in a condition engine and filtered for transmission based on condition criteria.

The present invention allows for event occurrences to be captured in a way to enable users to do attribute comparisons from multiple systems. An attribute may be one or more specific fields or conditions. Actions triggered by events and attributes matched from multiple sources require data mapping between disparate systems. Data structure conversions take place in any form of data transformation utilizing field sets, which may span over multiple instances.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic view showing the interrelationships of the essential components of a preferred embodiment of the present invention;

FIG. 2 is a flowchart showing details of the alert processing sequence within the Messaging/Push/Filtering and Condition Engine shown in FIG. 1.

### DESCRIPTION OF THE PREFERRED EMBODIMENTS

The following description is provided to enable any person skilled in the art to make and use the invention and sets forth the best modes presently contemplated by the inventor of carrying out his invention. Various modifications, however, will remain readily apparent to those skilled in the art, since the generic principles of the present invention have been defined herein.

Alerts in the present invention are based on the occurrences of events of interest within a supported information system. An event raised in an originating system triggers an Alert, which is registered within an embodiment of the present invention. The Alert registration specifies that either a message is to be forwarded to a destination user or system, or a process or transaction is to be executed as a result of receiving the Alert.

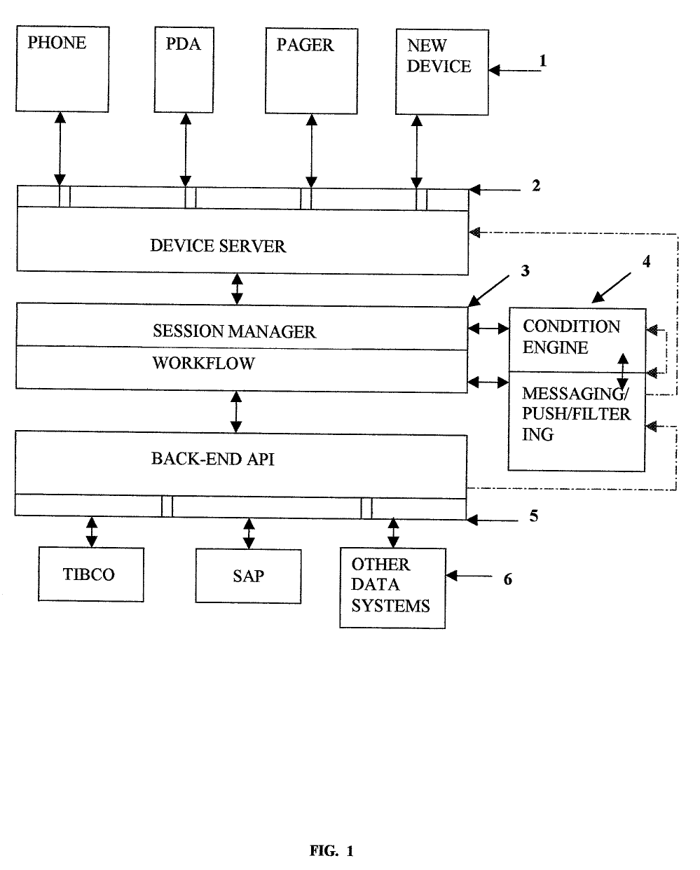

Referring to FIG. 1 of the drawings there is shown, generally at 6, a plurality of data systems in which certain events that may occur within those systems are subscribed to as Alerts. A back-end Applications Programming Interface is supplied, shown at 5, which forms an interface between the data systems and the present invention. This interface relays alerts to the Workflow A and Session Manager components, shown at 3, or to the Condition Engine and Filtering component, shown at 4. Alerts to be transmitted to a wireless device in their native format bypass the Condition Engine component, shown at 4, since no filtering or transformation of data is to be performed. Alternatively, alerts may be routed to the Message Filtering/Condition Engine component, where the alert is processed against a set of filter definitions and/or condition elements to determine whether the alert should continue to its final destination and what final form the alert should take before proceeding to its final destination. The final destination of all alerts are to any devices of a general class of wireless devices, such as Personal Digital Assistants, cellular telephones, traditional pagers, and the like, shown as 1. A Device Server component of the present invention, generally shown at 2, is included for completeness and represents an interface for an embodiment of the present invention to the wireless communication system that services wireless devices.

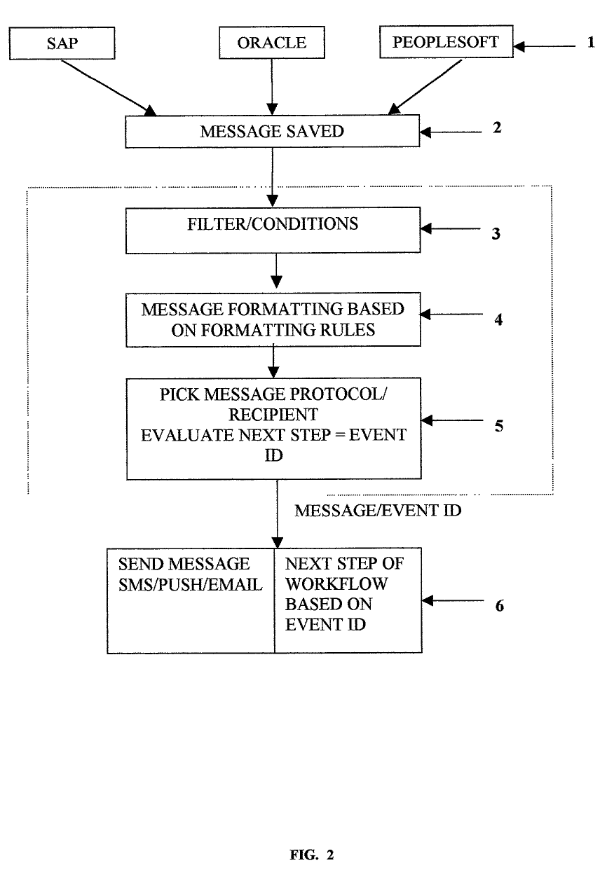

Referring now to FIG. 2 of the drawings there is shown, generally at 1, a plurality of information systems where events of interest are formed into alert messages and forwarded to a repository for storage, shown at 2. These alert messages are transferred from the repository shown at 2 and passed to the Filter/Conditions component, shown at 3. The Filter/Conditions component decides on whether the alert matches any filter registrations or condition expressions that resolve as to whether the alert is to continue to the next phase of processing. If so, the next processing step is shown at 4 and consists of the application of formatting rules that modify the physical message structure such that the final message will render correctly on the destination wireless device. Once this formatting process is complete, the next step, shown at 5, is to select the appropriate message protocol and recipient based on user configuration information and to determine the next step in the sequence. A decision point is reached at the step shown at 5 where the next step, shown generally at 6, is to either forward the final alert message to its intended destination device or to pass it to the next step in a predefined workflow.

An alert definition may span multiple systems of the same type or different types. A user uses an internal object repository to configure the conditions that determine whether messages are kept in the system for further processing or thrown away. An associated Action function specifies what to do with the message(s) triggered by the event. Dependencies between the system-specific events from multiple systems may be specified, and these dependencies may entail waiting on a condition, ignoring one or more conditions, and the like. Condition elements may be connected through dependency rules.

Alert occurrences trigger two types of actions: messages sent to users or devices called notifications, or the execution of one or more transactions in a source system. An example of a triggered transaction action may be a message indicating the shipping of a product triggering the Action ‘Invoicing’, which in turn, could automatically produce an invoice. Notifications are sent as messages to users, roles, devices, or other computer systems. They are triggered by user defined Events and are constructed from a filtering process based on Event Rules. A message can be any combination of string constants and variables. Roles are a group of users and/or systems with any hierarchical dependency. If the target of a message is a person, the message is sent to one or more designated devices, which may be in the possession or control of that person.

The present invention covers four types of conditions based on the type of objects on which they operate. Any of these condition types might refer to general or timing conditions. They are special in that they have a special focus on certain object types.

Types of Conditions

Workflow Condition

Alert Condition

Alert Group Condition

Timing Condition

Event Rules filter out the relevant messages that are to be sent to various target devices or systems. A filter is a condition in the form of a boolean expression of any complexity. The condition is set by the user and messages meeting no conditions are discarded. Operators of the condition criteria are the common operators for comparison; equal (“=”), less-than (“<”), less-than or equal (“<=”), greater-than (“>”), greater-than or equal (“>=”) and the logical negation of these operators. Condition elements may further be combined into more complex expressions using logical operators such as AND or OR. Condition groups may be built from several condition criteria where each criteria and condition group may trigger message delivery. Operands of the condition criteria may be field values, metadata names, time/date constraints, and periodicity. A condition element consists of operators and operands. Further, one or more condition elements may be combined using the boolean operators AND or OR to provide a condition expression of arbitrary complexity. Special condition elements are time and periodicity. The time special condition element is an element which deals directly with time. Among conditions which may be used to satisfy questions involving a date and/or time range including Specific Date And Time, Time of Day, Time of Hour, Hour of Day, Day of Week, Day of Month, Day of Year, Week of Month, Week of Year, Month of Year.

A variation of the special time condition includes duration. The duration condition seeks to answer the question “Is a specific date and time between time₁ and N units of time later?”

Another special condition element is periodicity. Periodicity is used to trigger an action that is to be repeated on a regular basis. Among conditions which may be used to satisfy questions involving a periodically recurring event include a range of recurrence including:

Start at date₁/time₁ and have no end date

Start at date₁/time₁ and end after N occurrences

Start at date₁/time₁ and end by date₂/time₂

Every N minutes

Every N hours

Every N days

Every weekday

Weekly

Every N weeks

on selected days of a week (any combination of days of the week)

Every N^{th} day of every M^{th} month

Monthly

Yearly

Timing Conditions can be combined with periodicity creating conditions like “Between 10:00 and 12:00 on every 3rd day starting on Jan. 31, 2001 and stopping after 15 occurrences.” In this case the Periodicity is at the day level further narrowed with Timing Condition of the time period.

An alert definition can span across multiple systems. A notification about an event (changes in inventory, request for price comparisons) may come from multiple systems at the same or at different times. Depending on the operation defined for the attributes of the notification (i.e. price, quantity, etc.) the filter needs to have conversion rules to be able to carry out the operation for a specific condition, which may involve one or multiple common attributes from disparate systems.

Each Alert has a default message associated with it. An Alert message is a string containing the actual message to be sent out with references to Function Expressions within the text. An alert can have many Function Expressions defined which can be included in the alert message text and substituted at the time of the occurrence of the alert.

For each device a specific alert message text can be defined to be used for that specific device. The text is set by the owner of the device if they wish to receive a different message from the default. The text of the alert message can reference all or a subset of the Function Expressions defined by the alert itself. Note that this text is not language dependent since it is for a specific device of a specific user.

Each Alert has one or more Alert Conditions or an Alert Group Condition associated with it. These are the conditions that are evaluated for the source system message. Recipients can subscribe to alerts. When the condition of an alert is evaluated to true, subscribers will get the alert message. A recipient can include Organization, Organization Role, User Group, Group Role Of User Group, User Group Role In Organization, or User.

Each recipient can have one Timing Condition associated with a subscription. For example, when users want to have certain times defined for periods when they don't want to be disturbed. A subscription can also have an expiration date, a maximum number of execution restrictions, and the subscription can be activated or deactivated.

Each Alert Condition has a Business Object Type associated with it. The Alert is to be “executed” when the Business Object Type in the source system message is the same as one of the Alert Condition Business Object Types associated with an Alert Condition. Business Object Types are source system independent objects with attributes. They are defined at condition configuration time, so we can present a selectable list of attributes of a certain Business Object type for the user to choose from when building the conditions.

A condition consists of one or more sub-condition groups. Each sub-condition group holds one or more sub-conditions which are connected with a single logical operator AND or OR. A condition can also be negated (reversed) with the NOT operator. A sub-condition group is a group of sub-conditions connected with the single logical operator AND or OR. A sub-condition is either a Function Expression or another Condition.

Alert Conditions operate on Business Objects as they are defined in the Alerts coming from the source system.

Alert Group Conditions are collections of Alert Conditions and Timing Conditions. Alert Group Conditions define a series of Alert conditions that should all be true within a given timeframe defined by the related Timing Condition(s). They determine if a series of events occurred within a certain time period. If true, they raise the Alert Notification. Alert Notifications are a special type of condition that consists of many other Alert Conditions plus a “Duration” type Timing Condition. The Duration Timing Condition defines a moving window in time, which the Alert evaluation process uses to decide whether the event participates in the evaluation. The child Alert Conditions are applied to all events that happen in the given time frame. An Alert is triggered when the Condition Group is evaluated to TRUE and there is at least one event for each child Condition for which it evaluates to TRUE.

These Condition Groups can be used to trigger related events happening relatively close to each other, for example creating a Sales Order in one source system that triggers the creation of a corresponding Purchase Order in a different source system that might be initiated at the same time. Condition Groups can be defined to wait for one another within a given time period.

Timing Conditions operate on only date/time related objects. They define conditions on the time of the Alert Notification, or any other date/time field.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A method for the automatic transmission of electronic information comprising:
a plurality of interconnected computing devices each capable of interfacing to wireless as well as land-based communication networks with each computing device including a processor, local storage, and a visual display;
a subset of such interconnected computing devices comprising computing devices of small physical stature tailored for use with a wireless network;
a subset of such interconnected computing devices comprising computing systems that contain data desired to be received by the devices of small physical stature;
a method for the generation of messages comprising forms of alerts to subscribed events originating from the computing systems containing data desired to be received by the devices of small physical stature;

2. The method of claim 1 further comprising:
a method for the generation of alerts that may be dynamically formatted for transmission and reception to a device tailored for use over a wireless network;

3. The method of claim 1 further comprising:
a method for alerts to include the capability to initiate execution of an executable program;

4. The method of claim 1 further comprising:
a method for alerts to include the capability to initiate execution of a data system transaction;

5. The method of claim 1 further comprising:
a method for the capture of an alert that enables a user to perform attribute comparisons from among multiple systems;

6. The method of claim 1 further comprising:
a method for associating either the source and/or destination of an alert to an individual user;

7. The method of claim 1 further comprising:
a method for associating either the source and/or destination of an alert to a logical grouping of users where the grouping is defined based on roles;

8. The method of claim 1 further comprising:
a method for associating either the source and/or destination of an alert to an identified physical device;

9. The method of claim 1 further comprising:
a method for alert messages to be transmitted in a format native to the originating system;

10. The method of claim 1 further comprising:
a method for a user to interact dynamically with an alert;

11. The method of claim 1 further comprising:
a method for the transmission of an alert based on the availability of an identified receiving device.
